(19) United States
(12) Patent Application Publication
(10) Pub. No.: US 2015/0308909 A1
(43) Pub. Date: Oct. 29, 2015

(54) FIBER OPTIC PIPELINE ACOUSTIC MEASUREMENT METHOD, DEVICE, AND SYSTEM

(71) Applicants: James Patrick CARNEAL, Wilmington, NC (US); Glen Peter KOSTE, Niskayuna, NY (US)

(72) Inventors: James Patrick CARNEAL, Wilmington, NC (US); Glen Peter KOSTE, Niskayuna, NY (US)

(73) Assignee: GE-HITACHI NUCLEAR ENERGY AMERICAS LLC, Wilmington, NC (US)

(21) Appl. No.: 14/260,697

(22) Filed: Apr. 24, 2014

(51) Int. Cl. G01L 1/24

(52) U.S. Cl. CPC G01L 1/242

(57) ABSTRACT

A method of monitoring a pipe using a measurement device connected to an optical fiber cable that is wrapped around the pipe along a length of the pipe includes generating a first light pulse such that the first light pulse propagates through the optical fiber cable towards the pipe; receiving, at the measurement device, a plurality of second light pulses reflected from a plurality of different reflection points within the optical fiber cable, respectively, the plurality of different reflection points being located at a plurality of different locations along the length of the pipe, the plurality of light pulses each being reflected forms of the first light pulse; and determining one or more optical path length (OPL) change measurements based on the plurality of second light pulses, the one or more OPL change measurements corresponding, respectively, to the one or more different location along the length of the pipe.

### BACKGROUND

1. Field

This disclosure relates generally to monitoring acoustics in pipes.

2. Description of Related Art

Pipelines carrying gases or liquids can also be conduits of acoustic signals from upstream or downstream equipment. The amplitude and frequency of the signals are indicative of the health or operating state of the upstream or downstream equipment. Accordingly, it is desirable to obtain measurements of acoustic pressure waves associated with pipes in order to help determine a status of the pipe, the substance(s) passing through the pipe, and/or machinery connected to the pipe.

### SUMMARY

One or more embodiments relate to an optical fiber sensor that determines acoustic pressure waves of a pipe.

According to at least one example embodiment, a method of monitoring a pipe using a measurement device connected to an optical fiber cable that is wrapped around the pipe along a length of the pipe includes generating a first light pulse such that the first light pulse propagates through the optical fiber cable towards the pipe; receiving, at the measurement device, a plurality of second light pulses reflected from a plurality of different reflection points within the optical fiber cable, respectively, the plurality of second light pulses each being reflected forms of the first light pulse; and determining one or more optical path length (OPL) change measurements based on the plurality of second light pulses received at the measurement device, the one or more OPL change measurements corresponding, respectively, to the one or more different locations along the length of the pipe.

The method may further include determining one or more hoop strain measurements of the pipe based on the one or more OPL change measurements.

The method may further include determining a condition of at least one of the pipe, machinery connected to the pipe, and a structure connected to the pipe based on the one or more hoop strain measurements.

The method may further include determining positions of the plurality of reflection points along a length of the optical fiber cable based on time-of-flights of the plurality of second light pulses, time-of-flights being defined such that, for each of the plurality of second light pulses, the time-of-flight of the second light pulse is an amount of time between when the first light pulse entered the optical fiber cable and when the second light pulse exited the optical fiber cable, the plurality of second light pulses being received at the measurement device at different times.

According to at least one example embodiment, a measurement device includes a processing unit, the measurement device being programmed such that the processing unit controls operations for monitoring a pipe using a an optical fiber cable that is connected to the measurement device and wrapped around the pipe along a length of the pipe, the operations including, generating a first light pulse such that the first light pulse propagates through the optical fiber cable towards the pipe; receiving, at the measurement device, a plurality of second light pulses reflected from a plurality of different reflection points within the optical fiber cable, respectively, the plurality of second light pulses each being reflected forms of the first light pulse; and determining one or more optical path length (OPL) change measurements based on the plurality of second light pulses received at the measurement device, the one or more OPL change measurements corresponding, respectively, to the one or more different locations along the length of the pipe.

The measurement device may further include an interferometer, the measurement device being programmed such that the processing unit controls the interferometer to perform the generating the first light pulse and the receiving the plurality of second light pulses.

The measurement device may further include the optical fiber cable.

The measurement device may be configured such that the processing unit controls determining one or more hoop strain measurements of the pipe based on the one or more OPL change measurements.

The measurement device may be configured such that the processing unit controls determining a condition of at least one of the pipe, machinery connected to the pipe, and a structure connected to the pipe based on of the one or more hoop strain measurements.

The measurement device may be configured such that the processing unit controls determining positions of the plurality of different reflection points along a length of the optical fiber cable based on time-of-flights of the plurality of second light pulses, the time-of-flights of the plurality of second light pulses being defined such that, for each of the plurality of second light pulses, the time-of-flight of the second light pulse is an amount of time between when the first light pulse entered the optical fiber cable and when the second light pulse exited the optical fiber cable, the plurality of second light pulses being received at the measurement device at different times.

According to at least one example embodiment, a pipe monitoring system includes an optical fiber cable wrapped around a pipe along a length of the pipe; a measurement device connected to the optical fiber cable, the measurement device being configured to, generate a first light pulse such that the first light pulse propagates through the optical fiber cable towards the pipe, and receive a plurality of second light pulses reflected from a plurality of different reflection points within the optical fiber cable, respectively, the plurality of second light pulses each being reflected forms of the first light pulse; and a computation unit configured to determine a condition of at least one of the pipe, machinery connected to the pipe, and a structure connected to the pipe based on the received plurality of second light pulses.

The measurement device of the pipe monitoring system may be further configured to determine one or more optical length (OPL) change measurements based on the plurality of second light pulses, the one or more OPL change measurements corresponding, respectively, to one or more different locations along the length of the pipe.

The measurement device of the pipe monitoring system may be further configured to send the one or more OPL change measurements to the computation unit, and the computation unit is further configured to determine one or more hoop strain measurements based on the one or more OPL change measurements, the computation unit being configured to determine the condition of at least one of the pipe, machinery connected to the pipe, and a structure connected to the pipe based on the one or more hoop strain measurements.

The measurement device of the pipe monitoring system may be further configured to determine the one or more of hoop strain measurements based on the one or more OPL change measurements, and the measurement system is further configured to send the one or more hoop strain measurements to the computation unit, the computation unit being configured to determine the condition of at least one of the pipe, machinery connected to the pipe, and a structure connected to the pipe based on the one or more hoop strain measurements.

The pipe monitoring system may further include the pipe.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 illustrates a pipe acoustics measurement system according to at least one example embodiment.

FIG. 2 illustrates a detailed view of the photonic acquisition.

FIG. 3 illustrates a cross section view of the pipe.

FIG. 4 is flow diagram illustrating an example method of operating the photonic acquisition unit according to at least one example embodiment

### DETAILED DESCRIPTION

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

While a number of example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

### Overview of Acoustic Pressure Detection in Pipes

As stated above, it is desirable to obtain measurements of acoustic pressure waves associated with pipes in order to help determine a status of the pipe, the substance(s) passing through the pipe, and/or machinery connected to the pipe.

As used herein, the term pipe refers to a pipeline or a section thereof.

One conventional method of measuring acoustic waves involves using pressure transducers. However, it is desirable to measure these acoustic pressure waves without penetrating or putting holes in the pipe as would be required if using pressure transducers. Another approach is to attach strain gauges to the outside the pipe and measure the strain changes, or hoop strain, induced by the pressure waves in the pipe. However, since strain gauges measure pressure at discrete locations, multiple gages must be attached around the circumference of the pipe to cancel out the effects of bending and vibration. The lengthy time required to install multiple strain gages on pipes may pose a significant drawback due to high installation costs and harsh environment exposure especially inside a nuclear power plant. Furthermore, the large number of wires routed back to measurement instrumentation requires a large cross-section which can be particularly troublesome, for example, when routing between different hazard zones such as from a high radiation zone to a lower radiation zone in a scenario where the pipes being monitored are part of, or connected to, a nuclear reactor.

Accordingly, it would be desirable to develop a sensor and a method of sensing that are capable of measuring acoustic pressure waves in pipes without requiring the drilling of holes in the pipes being measured or the use of a large number of different sensors to measure the pressure waves at different points along the pipe. Additionally, it would be desirable to develop a sensor and a method of sensing that are capable of measuring acoustic pressure waves at multiple location so as to reduce or cancel-out the effects, on acoustic pressure wave measurements, of bending and vibration in the pipe being monitored.

### Overview of Pipe Acoustics Measurement System

According to at least one example embodiment, a fiber optic acoustic pressure sensor can be used to determine acoustic pressure in a pipe by measuring hoop strain in the pipe using, for example, a single optical fiber cable. As will be discussed in greater detail below, according to at least one example embodiment, the fiber optic acoustic pressure sensor determines hoop strain in the pipe by determining changes in optical path length along the optical fiber cable at different locations on the pipe being monitored.

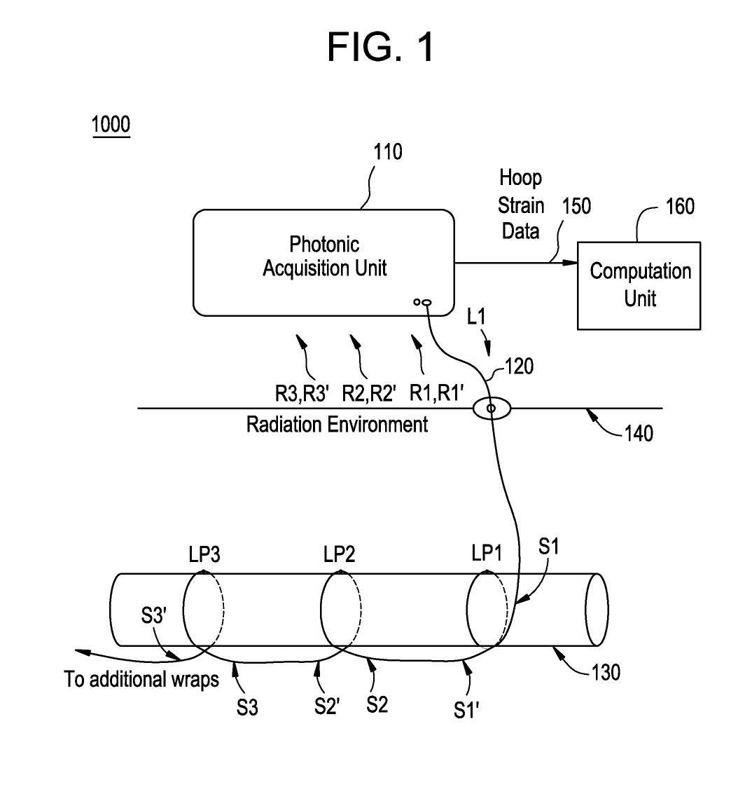

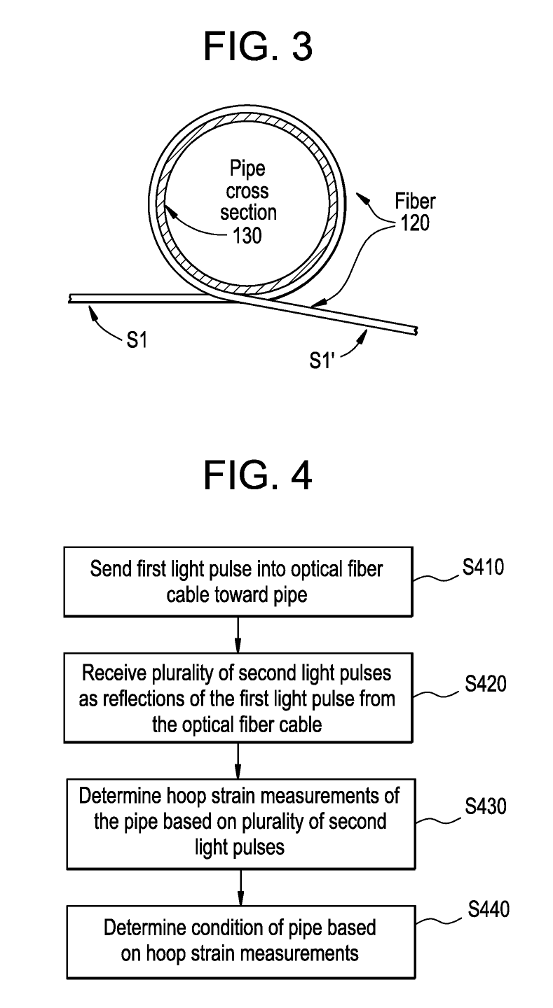

FIG. 1 illustrates pipe acoustics measurement system 1000. The pipe acoustics measurement system includes a photonic acquisition unit 110, an optical fiber cable 120, and a pipe 130. According to at least one example embodiment, pipe acoustics measurement system 1000 may also include a computation unit 160. The optical fiber cable is connected to the photonic acquisition unit 110 at one end and wrapped around the pipe 130 at the other. FIG. 3 illustrates a cross section view of the pipe 130. In a scenario where the pipe 130 is located in a hazardous area, according to at least one example embodiment, the photonic acquisition unit may be located in a different relatively safer and/or less hazardous location with respect to the pipe 130. For example, in the example illustrated in FIG. 1, the pipe 130 and a portion of the optical fiber cable 130 are located in a radiation environment 140. For example the pipe 130 may be part of, or connected to, a nuclear reactor system. Further, optical fiber cable 120 extends out of the radiation environment 140 to the photonic acquisition device 110, which is also located outside the radiation environment 140.

Though the pipe 130 is described above with reference to an example in which the pipe 130 is associated with a radiation environment, for example as part of a nuclear reactor system, according to example embodiment, the pipe 130 may be any type of pipe that one desires to know the condition of. For example, according to at least one example embodiment, the pipe 130 may be part of an oil and/or gas system.

As is illustrated in FIGS. 1 and 3, the optical fiber cable 120 is looped around an outer surface of the pipe 130 several times such that multiple loops of the optical fiber cable 120 are located, respectively, at multiple points along a length of the pipe 130. Further, as is illustrated in FIG. 3, each loop of the fiber cable 120 may be looped tightly around the wall of the pipe 130, for example, such that little or, alternatively, no space exists between each loop of the fiber cable 120 and the wall of the pipe 130. The optical fiber cable 120 includes scattering sites throughout the length of the cable. Further, according to at least one example embodiment, the scattering sites may be located in the interior of the optical fiber cable 120 and may include one or both of natural flaws in the optical fiber cable 120 and engineered reflectors including, for example, Bragg gratings.

### Overview of Photonic Acquisition Unit

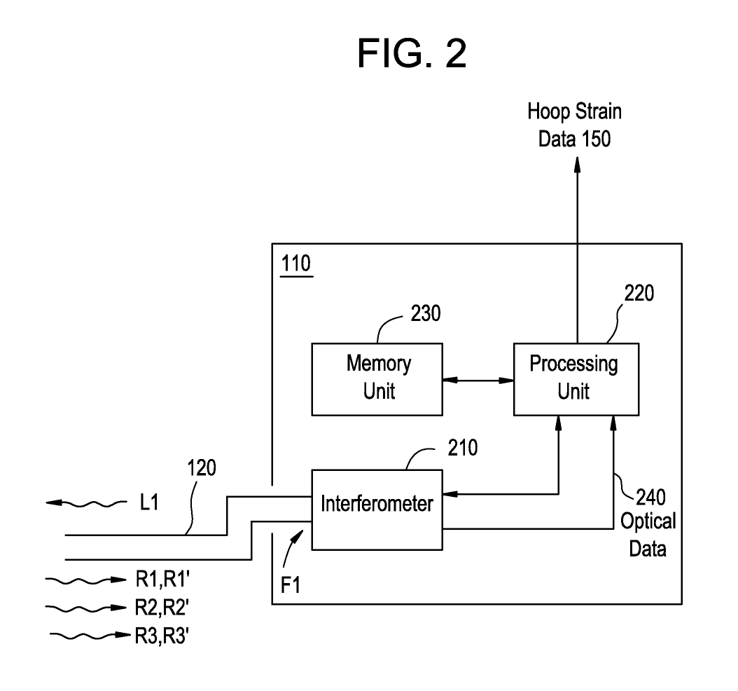

FIG. 2 illustrates a detailed view of the photonic acquisition unit 110. As is illustrated in FIG. 2, the photonic acquisition unit 110 includes an interferometer 210, a processing unit 220, and a memory unit 230. According to at least one example embodiment, the interferometer 210 may include a light source, for example laser and an optical receiver. The laser may be, for example, a low noise laser capable of generating short light pulses.

The interferometer 210 is connected to the optical fiber cable 120 and generates pulses of light, for example using the laser, such that the generated pulses of light propagate down the optical fiber cable towards the pipe 130.

Additionally, after the interferometer 210 generates a single pulse of light, the interferometer 210 receives, for example using the optical receiver, multiple pulses of reflected light corresponding to the single generated pulse of light. For example, as is discussed above with reference to FIG. 1, the optical fiber cable 120 includes scattering sites throughout the length of the cable. Accordingly, a single pulse of light sent down the optical fiber cable 120 may scatter of the scattering sites and generate several different pulses of reflected light corresponding, respectively, to several different scattering sites within the optical fiber cable 120. This phenomenon is illustrated in FIG. 1, for example, by light pulse L1, and first through third reflected light pulse pairs R1, R1′-R3, R3′. Light pulse L1 is a single light pulse generated by the interferometer 210 and sent down the optical fiber cable 120. First through third reflected light pulse pairs R1, R1′-R3, R3′, all reflected forms of the light pulse L1, are reflected from various positions in the optical fiber cable 120. The pulse pairs are interfered in the interferometer to provide a measure of the difference in OPL between the scattering site pairs. Although, one example process of using an interferometer to determine an OPL change based on a pair of reflected light pulses is discussed above, there are other known processes for using an interferometer to determine OPL changes based on a plurality of reflected pulses. Any known method of using an interferometer to determine OPL change based on reflected light in an optical fiber can be used in accordance with example embodiments.

For example, as is illustrated in FIG. 3, the optical fiber cable 120 may form, for example, 3 loops, LP1, LP2 and LP3, located at different positions along the pipe 120 as is illustrated in FIG. 1. Further, the first reflected light pulse pair (R1, R1′) may be reflected, respectively, from a first pair of scattering sites (S1, S1′) associated with the first loop LP1 as is illustrated in FIG. 1. For example, FIG. 3 also illustrates a first scattering site pair S1, S1′ corresponding to the first loop, LP1. The first pair of scattering sites (S1, S1′) correspond, respectively, to the first pair of reflected pulses (R1, R1′). For example, the first reflected pulse, R1, of the first reflected pulse pair (R1, R1′) may be reflected from the first scattering site, S1, of the first scattering site pair, (S1, S1′); and the second reflected pulse R1′ of the first reflected pulse pair, (R1, R1′), may be reflected from the second scattering site, S1′, of the first scattering site pair (S1, S1′). As is illustrated in FIG. 3, viewing the photonic acquisition unit 110 as a starting point of the fiber optic cable 120, according to at least one example embodiment, the first scattering site S1 of the first scattering site pair (S1, S1′) may be located in the vicinity of an entrance to the first loop LP1, e.g., where the first loop LP1 of the optical fiber cable 120 begins to wrap around the pipe 130; and the second scattering site S1′ of the first scattering site pair (S1, S1′) may be located in the vicinity of an exit of the first loop LP1, e.g., where the first loop LP1 of the optical fiber cable 120 ends. Further, the positions of scattering point pair (S1, S1′) on first loop LP1 illustrated in FIG. 3 are provided as an example. However, according to at least one example embodiment, the locations of the first scattering site pair S1, S1′ may be on respectively different portions of the first loop LP1, other that the entrance and/or the exit of the first loop LP1.

Further, in the same manner discussed above with reference to the first reflected pulse pair (R1, R1′) and the first scattering site pair (S1, S1′), the second reflected light pulse pair (R2, R2′) are reflected, respectively, from a second pair of scattering sites (S2, S2′) associated with the second loop LP2; and the third reflected light pulse pair (R3, R3′) are reflected, respectively, from a third pair of scattering sites (S3, S3′) associated with the third loop LP3.

The type of scattering taking place in the optical fiber cable may be, for example, Rayleigh backscatter. According to at least one example embodiment, the interferometer 210 interferes the reflected light pulses in order to detect light characteristics of reflected light pulses received at the interferometer 210 in accordance with known methods and generates optical data 240 indicating the light characteristics of the received reflected light pulses. The light characteristics may include, for example, information indicating a change in an optical path length (OPL) of the optical fiber cable determined based on the reflected light pulses in accordance with known methods.

The interferometer 210 is connected to the processing unit 220 and may send the optical data 240 to the processing unit 210. According to at least one example embodiment, the processing unit 220 controls the operations of the interferometer 210 and the memory unit 230.

The processing unit 220 includes hardware or, alternatively, hardware and software for performing light analysis operations. Further, according to at least one example embodiment, the processing unit 220 may include processing hardware including, for example, a microprocessor or multiprocessor, and the memory unit 230 may store program code that corresponds to the light processing operations and is executed by the processing hardware of the processing unit 220. Results of the light processing operations may be output as hoop strain data 150, for example, to the computational unit 160. The computational unit 160 may be any device capable of calculating, generating and/or analyzing data. For example, the computation unit 160 may be a mobile device, tablet, laptop or desktop computer running a pipe acoustics analysis program.

According to at least one example embodiment, the light analysis operations performed by the processing unit 220 include determining changes in OPL corresponding to the optical fiber cable 120, based on the optical data 240 received from the interferometer 210. According to at least one example embodiment, the light analysis operations performed by the processing unit 220 additionally include determining hoop strain measurements corresponding to the optical fiber cable 120, for example, using the determined changes in OPL.

According to at least one example embodiment, hoop strain data 150 sent from the photonic acquisition unit to the computational unit 160 is the optical data 240, and the computational unit 160 generates hoop strain measurements based on the optical data 240. According to at least one example embodiment, hoop strain data 150 sent from the photonic acquisition unit to the computational unit 160 includes change of OPL measurements determined by the photonic acquisition unit 110 in a manner that will be discussed in greater detail below, and the computational unit 160 generates hoop strain measurements based on the change in OPL measurements received from the photonic acquisition unit 110. According to at least one example embodiment, hoop strain data 150 sent from the photonic acquisition unit to the computational unit 160 includes hoop strain measurements determined by the photonic acquisition unit 110 in a manner that will be discussed in greater detail below.

For example, methods of using light characteristic information corresponding to reflected pulses of light are known. Accordingly, the light analysis operations performed by the processing unit 220 may include determining a change in OPL corresponding to the optical fiber cable 120 based on the light characteristic information of the reflected light pulses included in the optical data 240 in accordance with known methods.

Further, as will be discussed in greater detail below, according to at least one example embodiment, the light analysis operations performed by the processing unit 220 may include determining changes in OPL corresponding to several different locations along the length of the optical fiber cable 120. For example, in accordance with known methods, a change in OPL can be determined by analyzing a pair of reflected light pulses (e.g. R1, R1′) associated with a loop of the optical fiber cable 120 (e.g., LP1) around the pipe 130.

For example, according to at least one example embodiment, the processing unit 220 is aware of a point in time at which the interferometer sends light pulses down the optical fiber cable 120. Accordingly, using light pulse L1 and first through third reflected light pulse pairs (R1, R1′)-(R3, R3′) as examples, when the processing unit 220 receives optical data 240 indicating light characteristics of first through third reflected light pulse pairs (R1, R1′)-(R3, R3′), the processing unit 220 can determine the positions along the length of the optical cable from which each of the six individual pulses included in the first through third reflected light pulse pairs (R1, R1′)-(R3, R3′) were reflected using time-of-flight. For example, a time-of-flight may be defined as an amount of time that passes between the point in time at which a light pulse is sent down the optical fiber cable 120 and the point in time at which a corresponding reflected light pulse is received at the interferometer 210. Accordingly, by determining differences in time between when the light pulse L1 entered the optical fiber cable 120 and when each of the reflected light pulse pairs (R1, R1′), (R2, R2′), and (R3, and R3′) exited the optical fiber cable 120, the processing unit 220 can determine time-of-flights for each of first through third reflected light pulse pairs (R1, R1′)-(R3, R3′).

Thus, by using time-of-flight information, the processing unit 220 can identify light characteristic information corresponding to different desired points along a length of the optical fiber cable 120. Consequently, the processing unit 220 can identify information indicating a change in OPL and/or hoop strain information with respect to several different positions along a length of the optical fiber cable.

A manner in which time-of-flights of reflected pulses of light can be used to allow the photonic acquisition unit 110 to identify change in OPL and/or hoop strain corresponding to one or more desired positions along the length of the fiber optic cable 120 will now be discussed.

Determining Change in OPL and/or Hoop Strain for a Desired Position in the Optical Fiber Cable and/or Pipe

The distance light travels as a function of time is a useful parameter for analyzing multiple reflected light pulses corresponding to a single light pulse sent down an optical fiber because the multiple reflected light pulses are distinguished from one another by analyzing light reflected from the optical fiber at different times.

For example, the speed of light in a vacuum, c, is roughly 3×10⁸ m/s. The speed light travels in a medium is c/n, where n is the index of refraction for the medium through which the light is traveling. The index of refraction in glass optical fiber (a unitless value) is roughly 1.5. Accordingly, speed of light in glass optical fiber having an index of refraction of 1.5, denoted herein as c_{gf}, is, for example, c/(1.5)=2×10⁸ m/s. Accordingly, in order for the processing unit 220 to determine a change in OPL corresponding to loop LP1 along the length of the optical fiber cable 120, the processing unit 220 analyzes optical information corresponding to light which is reflected from a pair of points corresponding to the first loop LP1, for example reflected light pulses R1 and R1′.

For example, according to at least one example embodiment, the interferometer connects to the optical fiber cable 120 at a point F1 illustrated in FIG. 2. Further, as used herein, the point F1 represents the point at which light pulses generated by the interferometer 210 enter the optical fiber cable 120, and the point F1 represents the point at which light pulses reflected by the optical fiber cable 120 back towards the interferometer 210 exit the optical fiber cable. The point F1 is used for ease of description. However, it is to be understood that, according to at least one example embodiment, a position at which a light pulse enters the optical fiber cable 120 may not be identical to a point where a corresponding reflected light pulse exits the optical fiber cable 120, and both points may be in different locations within the interferometer 210.

In accordance with a scenario where scattering point pair (S1, S1′) from which reflected pulses R1 and R1′ are reflected, respectively, is located a distance d₁ meters from the point F1, light pulses reflected from scattering point pair (S1, S1′), respectively, will have to travel a distance of 2×d₁, since the light must enter the optical fiber cable 120 from the interferometer 210, travel over the distance d₁ to scattering point pair (S1, S1′), and then return over the distance d₁ back to point F1. Accordingly, a total distance traveled by first reflected light pulse pair (R1, R1′), including both travel before reflection at scattering point pair (S1, S1′) (as light pulse L1) and travel after reflection at scattering point pair (S1, S1′), is 2×d₁. Though, for the purpose of clarity, a scattering point pair is defined with respect to a single distance from point F1, as is illustrated in Applicants FIG. 3, the scattering points of a scattering point pair are separated from one another by some distance. For example, the distance d defined with respect to a scattering point pair may be the distance between point F1 and a first scattering point of the scattering point pair, while the second scattering point of the scattering point pair is understood to be some distance, (e.g. less than 1 m, 1 m, between 1 m and 5 m, 5 m, 10 m, between 1 m and 20 m, 20 m, or more than 20 m) away from the first scattering point of the scattering point pair. According to at least one example embodiment, a distance between scattering points of a scattering point pair may be known by an operator of the pipe acoustics measurement system 1000.

Thus, using x as an index, the time-of-flight, Tₓ, for a pair reflected pulses of light, (Rx, Rx′), reflected, respectively, from a scattering point pair (Sx, Sx′) located a distance dₓ, along a length of the optical fiber cable 120, from the point F1 can be calculated in accordance with the following expressions:

Tₓ=(2×dₓ)/c_{gf} (1)

Accordingly, using scattering point pair (S1, S1′) as an example, T₁, the time of flight associated with light reflected from scattering point pair (S1,S1′), is (2×d₁)/(2×10⁸)=d₁×10⁽⁻⁸⁾ s. Consequently, in a scenario where scattering point pairs (S1, S1′), (S2, S2′), and (S3 and S3′) are, respectively, 100, 200, and 300 meters away from the point F1 along the length of the optical fiber cable 120 (i.e., distances d₁, d₂, and d₃ are 100 m, 200 m, and 300 m, respectively), T₁=1 μs, T₂=2 μs, T₃=3 μs. Accordingly, light analysis operations performed by the processing unit 220 may include determining a change in OPL corresponding to the first loop LP1 on the optical fiber cable 120 by analyzing light characteristics information associated with the first reflected light pulse pair (R1, R1′). For example, the processing unit 220 distinguishes the light characteristics information corresponding to, for example, the first reflected light pulse pair (R1, R1′) from characteristics of other reflected light pulses by finding, in the optical data 240, light characteristics information corresponding to reflected light received at the interferometer 210 1 μs after the light L1 was generated and sent down the optical fiber cable 120.

Likewise, the processing unit 220 determines a change in OPL at a location of the second loop LP2 by analyzing light characteristics information corresponding to reflected light received at the interferometer 210 2 μs after the light L1 was generated Further, the processing unit 220 determines a change in OPL at location of the third loop LP3 by analyzing light characteristics information corresponding to reflected light received at the interferometer 210 3 μs after the light L1 was generated. Consequently, according to at least one example embodiment, in the same manner discussed above with respect to loops LP1, LP2 and LP3, the processing unit 220 can determine a change in OPL at any point along a length of the optical fiber cable 120 for which a corresponding pair of reflected light pulses exists. For example, though, for the purpose of clarity, FIG. 1 illustrates three loops LP1-LP3 of the optical fiber cable 120 with slack in between the loops, according to at least some example embodiments, the fiber cable 120 may be wrapped around portions or the entire pipe 130 in continuous loops without slack in between the loops. Further, based on information indicating the manner in which the optical fiber cable 120 is wrapped around the pipe 130 (e.g., a spacing between different loops of the optical fiber 120 along a length of the pie 130), a position along a length of the fiber optical cable may be translated into position along a length of the pipe. Consequently, according to at least one example embodiment, in the same manner discussed above with respect to the locations of loops LP1, LP2 and LP3, the processing unit 220 can determine a change in OPL at any location along a length of the pipe 130 for which a corresponding pair of reflected light pulses exists.

Further, a hoop strain measurement corresponding to a particular position in the optical fiber cable 120 may be determined based on a change in OPL detected at a particular position along the length of the optical fiber cable 120 and/or pipe 130. For example, a cross-sectional circumference of a pipe, for example the pipe 130, at a time t may be defied as:

C(t)=Cₙₒₘ+c(t), (2)

where, according to at least one example embodiment, Cₙₒₘ represents a base circumference of the pipe defined as a circumference of the pipe when no acoustic pressure wave induced hoop strain is experienced by the pipe, and c(t) represents a change in the circumference of the pipe at time t in meters. Time t is measured in seconds. The value c(t) may be defied using the following expression:

c(t)=c(t)_{rad}×λ/n/(2*π)/(1−EPEC), (3)

where c(t)_{rad} is change in OPL at time t, λ is the wavelength of the light being analyzed in meters, n is the index of refraction for the optical fiber cable, and EPEC is the effective photo-elastic coefficient. The values n and EPEC may be determined in accordance with known methods. According to at least one example embodiment, n may be 1.5 and EPEC may be 0.23.

Consequently, using, for example, equations (1), (2), and (3) discussed above, according to at least one example embodiment, the photonic acquisition unit 110 may determine hoop strain measurements for several desired points along the length of the pipe 130 in a particular time interval.

Equation (4) below represents hoop strain:

Hoop strain=c(t)/Cₙₒₘ, (4)

Further, in accordance with known methods, by determining hoop strain measurements at several different points along the pipe, the negative effects on hoop strain measurement accuracy caused by bending and vibration in the pipe may be reduced or, alternatively, canceled out.

Alternatively, according to at least one example embodiment, the photonic acquisition unit 110 may determine change in OPL measurements for several desired points along the length of the pipe 130 and provide the measurements to separate device also included in the pipe acoustics measurement system 1000, for example the computation unit 160, for conversion to hoop strain measurements at the external device.

Further, though, for the purpose for clarity, only three reflected light pulse pairs (R1, R1)-(R3, R3′), are illustrated in FIGS. 1 and 3, any number of reflected light pulses may be generated. For example, the number of reflected light pulses reflected by the optical fiber cable 120 in response to a single light pulse generated by the interferometer 210 may be based on the number of scattering points in the optical fiber cable. Further, though, for the purpose for clarity, only a single generated light pulse L1 is illustrated in FIGS. 1 and 3, the photonic acquisition device 110, may generate several pulses per time unit to be sent down the fiber optical cable using, for example, the interferometer 210. Consequently, a sample rate of the photonic acquisition device 110 is defined by the number of pulses generated and propagated down the optical fiber cable 120 per unit time. The sample rate of the photonic acquisition device 110 will now be discussed in greater detail below.

### Sample Rate of Photonic Acquisition Device

According to at least one example embodiment, an upper limit to a sample rate of the photonic acquisition unit 110 may be set based on the total distance, D, of the optical fiber cable 120. For example, using equation (1) above, the time-of-flight for a light pulse traveling all the way to the end of the optical fiber cable, T_{D} would be D×10⁽⁻⁸⁾ seconds. According to at least one example embodiment, the processing unit 220 controls the interferometer 210 such that after the interferometer 210 generates a first light pulse, the interferometer 210 does not generate a subsequent light pulse until after the first light pulse has traveled the entire distance D of the optical fiber cable 120 and returned to the interferometer 210. Consequently, according to at least one example embodiment, a minimum sample interval of the photonic acquisition device 110 may be, for example, one sample every D×10⁽⁻⁸⁾ seconds, which corresponds to a maximum sample rate of 1/(D×10⁽⁻⁸⁾) samples per second. Thus, according to at least one example embodiment, if D is 1000 m, a maximum sample rate of the photonic acquisition unit 110 may be set to 100 thousand samples per second (ksps).

Consequently, the photonic acquisition unit 110 is capable of performing a single iteration of a pipe acoustics measurement operation which includes measuring change in OPL and/or hoop strain at several different locations along the lengths of the optical fiber cable 120 and pipe 130 at a given point in time. Further, the photonic acquisition unit 110 is capable of performing several iterations of this pipe acoustics measurement operation per second, depending, according to at least one example embodiment, on a length of the optical fiber cable 120. Consequently, the photonic acquisition unit 110 is capable of collecting a substantial amount of OPL change and/or hoop strain measurements over time with relatively fine level of detail due to high sample rates, multiple measurement locations, and the mitigation of measurement accuracy reducing effects resulting from. Further, in accordance with known methods, the OPL change and/or hoop strain data generated by the photonic acquisition unit 110 may be used to determine a condition of the pipe 130 or equipment connected to the pipe 130. Example methods of operating the photonic acquisition unit 110 will now be discussed in greater detail below.

### Example Method of Operating the Photonic Acquisition Unit

FIG. 4 is flow diagram illustrating an example method of operating the Photonic Acquisition Unit 110 of the pipe acoustics measurement system 1000.

Referring to FIG. 4, in step S410, a first pulse is sent into the optical fiber cable 120. For example, as is discussed above with reference to FIGS. 1 and 2, the photonic acquisition unit 110 may generate the first light pulse such that the first light pulse enters the optical fiber cable 120 and propagates away from the photonic acquisition unit 110 towards the pipe 130. As is discussed above with reference to FIGS. 1 and 2, according to at least one example embodiment, the first light pulse may be generated by a low noise laser included in the interferometer 210 such that the first light pulse enters the optical fiber cable 120 at point F1.

In step S420, a plurality of second light pulses are received as reflections of the first light pulse from the optical fiber cable 120. For example, as is described above with reference to FIGS. 1 and 2, the photonic acquisition unit 110 may receive, from the optical fiber cable 120, a plurality of second light pulses which are reflections of the first light pulse sent in step S410 reflected from different scattering point pairs within the optical fiber cable 120. For example, the second light pulses may be received by an optical receiver inside the interferometer 210. Further, the photonic acquisition unit 110 may generate optical data 240 indicating light characteristics of the plurality of second light pulses.

In step S430, hoop strain measurements of the pipe 130 are determined based on the plurality of second light pulses. For example, as is discussed above with reference to FIGS. 1 and 2, the photonic acquisition unit 110 may use equations (1) and (2) to determine change of OPL measurements with respect to the optical fiber cable 120. The change of OPL measurements may be determined with respect to several different positions along the length of the optical fiber cable 120. Further, as is described above, the several different positions along the length of the optical fiber cable 120 can be translated into several corresponding positions along the length of the pipe 130, and vice versa, based on knowledge regarding the manner in which the optical fiber cable is wrapped around the pipe 130. Further, according to at least one example embodiment, the photonic acquisition device 110 may use equations (3)-(4) to convert the change in OPL measurements to hoop strain measurements.

Alternatively, according to at least one example embodiment, one or both of the optical data 240 and the change in OPL measurements may be sent from the photonic acquisition unit 110 to one or more additional computation units, including for example computation unit 160, to be used by the one or more additional computation units to determine the change in OPL measurements and/or the hoop strain measurements.

In step S440, a condition of the pipe 130 or equipment connected to the pipe 130 is determined based on the hoop strain measurement determined in step S430. For example, according to at least one example embodiment, steps S410-S430 may be completed at any sample rate possible given a length of the optical fiber cable 120. Examples of sample rates at which steps S410-S430 may be completed include 1 ksps, 10 ksps and 100 ksps. Accordingly, a substantial amount of combined hoop strain data is generated throughout multiple iterations of steps S410-S430. This combined hoop strain data represents hoop strain measurements from multiple different lateral locations along a length of the pipe 130 at several different points in time. Accordingly, the combined hoop strain data may be used to analyze detailed patterns of hoop strains experienced by the pipe 130. In accordance with known methods, this combined hoop strain data may be used to determine different conditions in the pipe 130 depending on the application for which the pipe 130 is being used. The analysis of the combined hoop strain data and/or the determination of the condition of the pipe 130 may be completed by the pipe acquisition unit 110. Additionally or alternatively, the combined hoop strain data may be sent to, or calculated by, one or more additional computation units including, for example, the computation unit 160, and the one or more additional computation unit may complete the analysis of the combined hoop strain data and/or the determination of the condition of the pipe 130, based on the combined hoop strain data.

For example, the combined hoop strain data can be used to identify vibration patterns, pipe stress or other flow related characteristics experienced by the pipe 130. Further, these flow related characteristics can indicate pump inefficiencies, turbulence, cavitation, or other possible negative states being experienced by the pipe. This knowledge can then be used by an operator of the system to which the pipe 130 is connected to address or prevent dangerous and/or costly problems in the pipe 130 or the system to which the pipe 130 is connected.

According to at least one example embodiment, the photonic acquisition device 110 may be programmed, in terms of software and/or hardware, to perform any or all of the functions described herein as being performed by the photonic acquisition device 110 including, for example, operations described with reference to FIG. 4. For example, the processing unit 220 may be or include any device capable of processing data including, for example, a processor. As used herein, the term ‘processor’ refers to a machine that is structurally configured to carry out specific operations, or structurally configured to execute instructions included in computer readable code. Examples of the above-referenced processor include, but are not limited to, a microprocessor, a multiprocessor, a central processing unit (CPU), a digital signal processor (DSP), an application specific integrated circuit (ASIC), and a field programmable gate array (FPGA).

Examples of the photonic acquisition device 110 being programmed, in terms of software, to perform any or all of the functions described herein as being performed by the photonic acquisition device 110 will now be discussed below. For example, the memory unit 230 may store a program including executable instructions corresponding to any or all of the operations described herein as being performed by the photonic acquisition device 110 including, for example, operations described with reference to steps S410-S440 of FIG. 4. According to at least one example embodiment, additionally or alternatively to being stored in the memory unit 230, the program may be stored in a computer-readable medium including, for example, an optical disc, a flash drive, an SD card, etc., and the photonic acquisition device 110 may include hardware for reading data stored on the computer readable-medium. Further, the processor unit 220 may be or include processor configured to perform any or all of the operations described herein as being performed by the photonic acquisition device 110 (including, for example, operations described with reference to steps S410-S440 of FIG. 4) for example, by reading and executing the executable instructions stored in at least one of the memory unit 230 and a computer readable storage medium loaded into hardware included in photonic acquisition device 110 for reading computer-readable mediums.

Examples of the photonic acquisition device 110 being programmed, in terms of hardware, to perform any or all of the functions described above with reference to FIG. 4 will now be discussed below. Additionally or alternatively to executable instructions corresponding to the functions described above with reference to FIG. 4 being stored in a memory unit or a computer-readable medium as is discussed above, the processor unit 220 may include a circuit that has a structural design dedicated to performing any or all of the operations described with reference to steps S410-S440 of FIG. 4. For example, the circuit included in the processing unit 340 may be a processor physically programmed to perform any or all of the operations described herein as being performed by the photonic acquisition device 110 (e.g., an FPGA or ASIC).

Embodiments of the invention being thus described, it will be obvious that embodiments may be varied in many ways. Such variations are not to be regarded as a departure from the invention, and all such modifications are intended to be included within the scope of the invention.

What is claimed:

1. A method of monitoring a pipe using a measurement device connected to an optical fiber cable that is wrapped around the pipe along a length of the pipe, the method comprising:
generating a first light pulse such that the first light pulse propagates through the optical fiber cable towards the pipe;
receiving, at the measurement device, a plurality of second light pulses reflected from a plurality of different reflection points within the optical fiber cable, respectively, the plurality of second light pulses each being reflected forms of the first light pulse; and
determining one or more optical path length (OPL) change measurements based on the plurality of second light pulses received at the measurement device, the one or more OPL change measurements corresponding, respectively, to the one or more different locations along the length of the pipe.

2. The method of claim 1, further comprising:
determining one or more hoop strain measurements of the pipe based on the one or more OPL change measurements.

3. The method of claim 2, further comprising:
determining a condition of at least one of the pipe, machinery connected to the pipe, and a structure connected to the pipe based on the one or more hoop strain measurements.

4. The method of claim 1, further comprising:
determining positions of the plurality of reflection points along a length of the optical fiber cable based on time-of-flights of the plurality of second light pulses, time-of-flights being defined such that, for each of the plurality of second light pulses, the time-of-flight of the second light pulse is an amount of time between when the first light pulse entered the optical fiber cable and when the second light pulse exited the optical fiber cable, the plurality of second light pulses being received at the measurement device at different times.

5. A measurement device comprising:
a processing unit, the measurement device being programmed such that the processing unit controls operations for monitoring a pipe using a an optical fiber cable that is connected to the measurement device and wrapped around the pipe along a length of the pipe, the operations including,
generating a first light pulse such that the first light pulse propagates through the optical fiber cable towards the pipe;
receiving, at the measurement device, a plurality of second light pulses reflected from a plurality of different reflection points within the optical fiber cable, respectively, the plurality of second light pulses each being reflected forms of the first light pulse; and
determining one or more optical path length (OPL) change measurements based on the plurality of second light pulses received at the measurement device, the one or more OPL change measurements corresponding, respectively, to the one or more different locations along the length of the pipe.

6. The measurement device of claim 5 further comprising:
an interferometer, the measurement device being programmed such that the processing unit controls the interferometer to perform the generating the first light pulse and the receiving the plurality of second light pulses.

7. The measurement device of claim 5 further comprising:
the optical fiber cable.

8. The measurement device of claim 5, wherein the measurement device is configured such that the processing unit controls determining one or more hoop strain measurements of the pipe based on the one or more OPL change measurements.

9. The measurement device of claim 8 wherein the measurement device is configured such that the processing unit controls determining a condition of at least one of the pipe, machinery connected to the pipe, and a structure connected to the pipe based on of the one or more hoop strain measurements.

10. The measurement device of claim 8 wherein the measurement device is configured such that the processing unit controls determining positions of the plurality of different reflection points along a length of the optical fiber cable based on time-of-flights of the plurality of second light pulses, the time-of-flights of the plurality of second light pulses being defined such that, for each of the plurality of second light pulses, the time-of-flight of the second light pulse is an amount of time between when the first light pulse entered the optical fiber cable and when the second light pulse exited the optical fiber cable, the plurality of second light pulses being received at the measurement device at different times.

11. A pipe monitoring system comprising:
an optical fiber cable wrapped around a pipe along a length of the pipe;
a measurement device connected to the optical fiber cable, the measurement device being configured to,
generate a first light pulse such that the first light pulse propagates through the optical fiber cable towards the pipe, and
receive a plurality of second light pulses reflected from a plurality of different reflection points within the optical fiber cable, respectively, the plurality of second light pulses each being reflected forms of the first light pulse; and
a computation unit configured to determine a condition of at least one of the pipe, machinery connected to the pipe, and a structure connected to the pipe based on the received plurality of second light pulses.

12. The pipe monitoring system of claim 11, wherein the measurement device is further configured to determine one or more optical length (OPL) change measurements based on the plurality of second light pulses, the one or more OPL change measurements corresponding, respectively, to one or more different locations along the length of the pipe.

13. The pipe monitoring system of claim 12, wherein the measurement device is further configured to send the one or more OPL change measurements to the computation unit, and the computation unit is further configured to determine one or more hoop strain measurements based on the one or more OPL change measurements, the computation unit being configured to determine the condition of at least one of the pipe, machinery connected to the pipe, and a structure connected to the pipe based on the one or more hoop strain measurements.

14. The pipe monitoring system of claim 12, wherein the measurement device is further configured to determine the one or more of hoop strain measurements based on the one or more OPL change measurements, and the measurement system is further configured to send the one or more hoop strain measurements to the computation unit, the computation unit being configured to determine the condition of at least one of the pipe, machinery connected to the pipe, and a structure connected to the pipe based on the one or more hoop strain measurements.

15. The pipe monitoring system of claim 11, further comprising:
the pipe.
